(19) United States
(12) Patent Application Publication
(10) Pub. No.: US 2012/0296740 A1
(43) Pub. Date: Nov. 22, 2012

(54) SYSTEM AND METHODS FOR SELECTIVELY IMPLEMENTING ENDORSEMENTS AND VERIFYING ENDORSEMENT COMPLIANCE

(76) Inventors: Adam Fridman, Northbrook, IL (US); Jeffrey G. Sogolov, Hawthorn Woods, IL (US)

(21) Appl. No.: 13/190,814

(22) Filed: Jul. 26, 2011

Related U.S. Application Data
(60) Provisional application No. 61/487,835, filed on May 19, 2011.

(51) Int. Cl. G06Q 30/00

(52) U.S. Cl. 705/14.52; 705/14.4

(57) ABSTRACT

A system and method of implementing endorsements on mobile objects such that brands can recruit advertisers to promote their products and services in exchange for a reward. The method also allows for verification of compliance with the endorsement requirements submitted by the brands. Furthermore, the methods of the present invention allow for advertisers to solicit or approach brands whose services they want to promote.

### CLAIM OF PRIORITY

This application claims the benefit of U.S. Provisional Patent Application Ser. No. 61/487,835 filed May 19, 2011, the disclosure of which is incorporated herein by reference in its entirety.

### FIELD OF THE INVENTION

This invention relates to a system and methods for advertising and marketing products and services. More specifically, the invention relates to a system and methods for increasing brand awareness sales of products or services to consumers through the selective implementation of endorsement programs and verifying consumer participation in the same. The invention further relates to a system and methods for connecting brands and advertisers for such selective implementation of endorsements.

### BACKGROUND OF THE INVENTION

In today's competitive market, advertising and marketing budgets make up a substantial percentage of companies' expenditures. Many companies often employ many different strategies, technologies, and marketing and advertising channels with hopes of attracting just the right consumer. Other companies, however, in part because of the cost, utilize a single or more limited set of tools to reach consumers. While such a limited advertising program is less expensive the question remains whether it is cost effective. Did the company's message reach what the company believes is the ideal audience? Did it produce the desired effect? Consumer studies can be done to help answer these questions. However, such studies are time consuming and expensive. As a result, many businesses rely on trial and error methods, and change advertising and marketing methods until they believe they have figured out what works best.

As the advertising landscape continues to change and evolve, companies develop new methods of effective advertising and marketing. Some companies have realized the value in advertising on or in, for example, moving objects, be it a motor vehicle, a person, or a non-motorized moving object. Advertisements are also already being displayed on cars, clothing worn by a person, and other moving objects. Likewise, advertisements are being displayed on houses, fences, buildings, billboards or other exterior surfaces.

One conventional method that companies employ to deliver advertisement messages to consumers is to make wearing apparel that contains the message of a company available to consumers. Such wearing apparel can be that made through licensing arrangements formed with manufacturers. The licensed merchandise—carrying the company's logo or other message—ultimately is sold through retailers to consumers. Such wearing apparel can also be made by or for the company that wishes its message to be distributed to the public. This wearing apparel is often just given away as a promotional item.

Still, however, companies are constantly seeking new ways to get their messages in front of consumers in order to hopefully alter their purchasing behavior and choose the products and services the companies are offering. There is currently no convenient way to reward a consumer for choosing to publicize a company's message and thereby inform the public that the consumer has made that choice, for connecting brands with potential advertisers of brands, or for brands and consumers to conveniently and efficiently select each other.

Also, in the currently available systems, there is no convenient and efficient way of verifying that an advertisement is properly displayed and the advertiser adheres to the requirements of the brand it advertises. This is especially important in view of the mobile nature of the advertisers (those displaying the advertisements). Such verification is desirable for computation of compensation, endorsement, or other benefit conferred on the advertiser. Some companies offer intricate scanning or tracking mechanisms that necessitate further investments into various devices. For example, some systems call for on-road tracking systems that film or otherwise record the moving object to verify that the advertisement has been properly displayed. Other systems call for scanning of the advertisement at participating entities, necessitating the investment into scanning devices. Simply put, there is no simple and efficient system to verify compliance with the advertisement parameters set by the brands.

A need therefore exists for a system and methods by which advertisers can get rewarded for choosing to publicize a brand's message and thereby inform the public or, in other words, announce that the advertiser has made that choice. It is therefore desirable to improve the currently available methods of advertising and marketing on mobile objects and persons, as well as on stationary objects, such as houses, fences, storefronts, or other non-moving objects. It is desirable to have a platform that allows communication between brands and potential brand advertisers. There is also a need to have a more efficient way of verifying compliance with advertising parameters. The present invention satisfies these needs.

### SUMMARY OF THE INVENTION

According to one exemplary embodiment of the present invention, a brand, potentially through brand owner, retailer, manufacturer, licensee, or an advertising agency, will engage a platform to develop a campaign through which the platform will identify and recruit target advertisers who will receive an offer from a brand containing brands terms and conditions (parameters). Those target advertisers who accept the offered parameters and communicate their acceptance to the platform will become the advertisers for that brand. The platform will then cause an advertisement device to be manufactured or printed and delivered to the advertisers and the advertisers will display it on or in association with an advertising medium consistent with the brand parameters. The advertiser will then participate in one or more verifications to determine that the advertisement device is, indeed, properly affixed to the advertisement medium for some pre-determined duration of time. When the advertiser passes the one or more verifications, the advertiser will be eligible to receive a reward.

The platform may be accessed through a network architecture using an on-line portal or otherwise, by phone, email, or submission of a form in person or electronically, for example. The brand and platform will form a service relationship by which the platform will run the recruitment of target advertisers. The brand will submit its offer, including the consideration, terms, potential co-branding choices, restrictions or other rules, collectively, the brand parameters, to the platform. The brand parameters may be submitted to the platform by sending an email or entering a post. The platform is preferably a web-portal or another on-line or off-line environment, such as a web or mobile application, or a stand-alone kiosk, for example. Brand parameters may then be featured on the portal or otherwise communicated to target advertisers, for example, by email or SMS/MMS in order to recruit potential advertisers. The advertisers and brands may, collectively be referred to as participants.

The brand will also present its message, which can be an advertisement, endorsement, a set of information, a logo, or a charitable affiliation. The message will be displayed on the advertisement device, which may be a bumper sticker, a car window decal, a clothing sticker or patch, a license plate frame, a painted design, an electronic sign inside or outside the vehicle, or another similar device. The message can vary in size and content. The brand may, for example, also specify the type of advertising medium, such as a car, and part of the car on which its advertisements are to be displayed, some preferring bumpers, while others requesting back windshields or car doors. Additionally, the brand may specify the duration of campaign, verification preferences, car model and year, education level, driver profile, and other terms.

It is contemplated that the platform may include a counter component accessible through the on-line portal that communicates the number of advertisers participating. Specifically, the counter component may communicate the status of advertisers such as which advertisers or number of advertisers that are currently enrolled, active, accepted, verified or any other status indicator.

According to the present invention, it is preferable that the message is displayed on an analog device. The device may be delivered to the advertiser pre-printed or blank, allowing the advertiser to apply the message. For example, in the case of a bumper sticker, it may be sent with the pre-printed message and there may be a variety of messages or logos for advertisers to choose from under the same brand. Alternatively, the advertiser may apply the message by running it through a printer.

Alternatively, according to another exemplary embodiment, an advertiser may access the on-line platform and browse a list of potential brands whose message it may wish to display. Thus, instead of brands looking for advertisers and advertisers looking for brands to advertise, such as situations where the platform ultimately recruits advertisers, advertisers may offer their advertising services to a particular brand or group of brands, and instead, make their own offer having their advertiser parameters, thereby recruiting brands. Alternatively, advertisers may form a community or a similar group and make offers for open-ended endorsement, allowing the brands to bid on the group of advertisers with the quality or amount of the rebates, coupons, or compensation. For example, a group of 100 advertisers may offer its group services to whichever restaurant gives them the best promotion or deal. As such, brands may be selected by the advertisers, who may be an individual, a group of individuals, a business, social club, or other similar group.

The advertisers may offer to advertise a brand and receive discounts, promotions, monies, donations to their favorite cause, or other consideration from the brand, collectively rewards, in return. The advertisers may offer individual affiliations or group affiliations, by which they will bring a certain number of participants to a brand, to either qualify for consideration, increase consideration, or receive some other benefit. The consideration can also be staggered, based on the number of participants. Some campaigns or rewards may only be activated once a pre-determined number of participants sign up. While brands are usually commercial entities, it is understood that brands may be charitable organizations seeking to spread charitable messages. In such cases, there may not be a monetary benefit that is conferred on the advertiser for displaying the message.

Regardless of whether brands seek advertisers or advertisers seek brands, once a respective party has engaged the portal to develop its campaign, issued its offer containing parameters, and received notice of acceptance of the offer, an advertisement device is provided to the advertisers. The advertisement device is publicly displayed by the advertiser according to the brand parameters. It is contemplated that the advertisement device is an analog device and that it is displayed on or in association with a physical or analog surface of an analog advertisement medium such as, for example, the bumper of a car, a fence, or a window decal.

Additionally, certain verification mechanisms are implemented to make sure that the advertisers are displaying the advertisement devices properly, where necessary, according to the presented parameters. There are varying degrees of verification, based on brands' tolerance for ensuring compliance.

According to an exemplary embodiment, and by way of example, if the advertising device is a bumper sticker, the following verification can take place once an advertiser has signed up to a campaign and has received the advertising device, a bumper, rear windshield or vehicle body sticker. An advertiser will capture an image of the advertising device affixed to a car and with the license plate showing and upload it to the platform such as a web portal. The web portal will have a so called landing page for each brand through which further communications can take place between the brand and its advertisers. Likewise, certain groups of advertisers that promote a certain brand together may be able to have their own landing page. The image will be saved in the advertiser account, referenced by license plate number, name, email address, or another unique identifier. Next, at the option of the participating brand, the image may be analyzed for any modifications or alterations. Such analysis may be done manually by an employee at the web portal or a third party. Alternatively, the image of the advertising device may be analyzed with the help of software. Open source software such as JPEGSnoop™ may be utilized. A combination approach may be utilized by some brands, where both software and manual analyses may be employed. The kind and extent of image analysis is dictated by the brands. The analysis preferences may or may not be made public to the advertisers of the particular brand.

When the advertising device is a bumper sticker or a window decal, there may be additional built-in security measures in the sticker or decal. For example, there may be a physical crease that can only be leveled out when the back is peeled and the sticker or decal is affixed to a surface. If the sticker or decal is not properly affixed to a bumper or another car surface, the crease will show and the advertiser will not pass the verification. Similar methods can be implemented on other advertising devices.

The above-described verification of advertisement device preferably occurs at the start of the campaign to ensure that the advertising device, in this case, the bumper sticker, has been properly affixed to the car. After a period of time specified by the brand, a second verification can take place. At the second step, the advertiser will receive a unique instruction and will be asked to take and upload a second image of the advertising device based on the unique instruction. According to an exemplary embodiment, the instruction may be to open the trunk of the car, roll down a specific window, place an object on top of the car, or another similar instruction. Such a unique instruction will be randomly generated at the portal and sent to the advertiser for implementation. Then, as previously, the image will be analyzed for alterations or modifications. The analysis may be manual, software, or a combination analysis. The second verification step can be repeated in pre-set intervals of time throughout the campaign, or done only once, at the end of the campaign, after the advertiser has displayed the advertising device for some pre-determined period of time. According to an exemplary embodiment, the unique instruction may be implemented also in the first verification step, as well as in subsequent verifications. Some brands may wish to have regular verifications, for example, every 4 weeks, whereas others may wish to only have a first or a first and last verification, where the last verification takes place at the end of a campaign. Such preferences are usually dictated by the brands. However, when advertisers solicit brands, it may be possible to have the advertisers present their verification preferences in advertiser parameters or otherwise.

The described embodiments are to be considered in all respects only as illustrative and not restrictive, and the scope of the invention is not limited to the foregoing description. Those of skill in the art will recognize changes, substitutions and other modifications that will nonetheless come within the scope of the invention and range of the claims.

### BRIEF DESCRIPTION OF THE DRAWINGS

The preferred embodiments of the invention will be described in conjunction with the appended drawing provided to illustrate and not to the limit the invention, where like designations denote like elements, and in which:

FIG. 1 is a flowchart of a method of the present invention according to an exemplary embodiment.

FIG. 2 is a diagram of a system of the present invention according to an exemplary embodiment.

FIG. 3 is a flowchart of a method of the present invention according to another exemplary embodiment.

FIG. 4 is a diagram of a network architecture through which a platform of the present invention may be accessed according to an exemplary embodiment.

### DETAILED DESCRIPTION OF THE INVENTION

According to an exemplary embodiment, the present invention provides a system and methods for connecting brands and advertisers of brands, for rewarding advertisers for publicizing a brand's message and announcing their choice to publicize the brand's message, and for verifying advertiser compliance with brand parameters.

A system is established by which a brand, potentially through brand owner, retailer, manufacturer, licensee, or an advertising agency, will engage a platform to develop a campaign through which the platform will identify and recruit target advertisers who will receive an offer from a brand containing brands terms and conditions (parameters). One embodiment of such system is carried out through an on-line portal. Alternatively, the system may be implemented in an off-line environment, at a stand-alone kiosk, through mobile technology, print, or other environments. Those target advertisers who accept the offered parameters and communicate their acceptance to the platform will become the advertisers for that brand. The platform will then cause an advertisement device to be manufactured or printed and delivered to the advertisers and the advertisers will display it on or in association with an advertising medium consistent with the brand parameters. The advertisement device and advertisement medium are preferably analog and the advertisement device is preferably attached to or associated with a surface of the advertisement medium. The advertiser will then participate in one or more verifications to confirm that the advertisement device is, indeed, properly affixed to the advertisement medium for some pre-determined duration of time. When the advertiser passes the one or more verifications, the advertiser will be eligible to receive his reward for compliance with the brand parameters.

For example, a doctor's office may be looking to advertise its office and services. The doctor's office may wish to recruit drivers to promote it. Its model may be that it will compensate the selected drivers $x/month for displaying the advertisement, a bumper sticker, for example, that says “Just got my teeth cleaned at Dr. X” or another message. The Dr. Office (brand) will engage an on-line portal to help select potential advertisers. The Dr. Office will then submit an offer including its brand parameters. For example, it may submit that it is looking for drivers between the ages of 20-45 who live in the Downtown Chicago area. It may also post that the participating drivers (advertisers) must verify compliance every four weeks and display the bumper sticker (advertisement device) for a minimum of six months. It may further specify that it requires single endorsement, that is, only its advertisement can be displayed on that vehicle. Some or all of the parameters may have to be met by potential advertisers. Some brands may allow certain parameters to be waived, such as, for example, age.

The web portal will cause a landing page to be created for the doctor and cause the bumper stickers to be manufactured. The portal will then search its database of participants to recruit advertisers for this campaign. Advertisers may be recruited from the outside, as well. To sign up, the advertisers would go to the doctor's landing page at the portal and sign up for the campaign and accept the Dr. Office's offer, which includes the brand parameters. Once the brand receives acceptance notification from the advertisers that its brand parameters have been accepted by an advertiser, the advertiser will receive an advertisement device. In the present example, such advertisement device may be but is not limited to, a bumper sticker or a window decal. Each advertiser will then affix the advertisement device to their advertisement medium such as, for example, a car, truck, motorcycle, boat or another moving vehicle. Each advertiser will then participate in a verification process conducted by the portal and submit a picture or series of pictures of the advertisement device affixed to the advertisement medium to the portal. The details, duration, and frequency of the verification depend on the brand parameters submitted by the brand. Once the brand parameters have been satisfied, the advertiser will receive his reward. For example, he may be compensated by PayPal, check, direct deposit, reward points or other method of compensation.

Alternatively, instead of the portal recruiting advertisers or in addition thereto, the brand may hand out the advertisement devices directly or through a third party, to interested advertisers. Such advertisers would still need to register at the portal and sign up for the campaign by accepting the offer containing the brand parameters.

According to another embodiment, a restaurant, for example, may wish to have advertisers promote it in exchange for a discount coupon. The restaurant may engage the portal to find advertisers and create an advertisement device in the form of a bumper sticker. The restaurant may hand out the bumper stickers to its customers as well as have the portal recruit advertisers who will promote the restaurant by displaying its bumper sticker. Alternatively, the bumper stickers may be sold to advertisers for a fee by the restaurant, the portal or both. For example, the advertisers may pay $10 for a bumper sticker and display it for a certain period of time on their vehicle in exchange for receiving a 70% discount on at the restaurant upon completion of the campaign.

Still further, charitable organizations may engage the portal to recruit advertisers to promote causes. The advertisers would receive a pre-printed or customizable advertising device from the portal or the charitable organization, display the device on the vehicle or another advertising medium, go through the verification process, if required, and complete the campaign. The reward in such scenarios would be the inclusion in a charitable campaign. Some charitable organizations and other brands may have quotas on the number of advertisers they will accept into a certain campaign, creating a limited market for certain promotions. Alternative rewards may be points or other non-monetary currency usable at the portal or otherwise. Rewards may also be perks, such as tickets or passes to popular events. Rewards may also be earned by referring other participants to the portal.

In yet another embodiment, an advertiser or a group of advertisers may engage the portal to recruit a brand that they would like to promote. The advertiser or group of advertisers will engage the portal to have a landing page created at the portal and offer its own parameters there. Such parameters may be referred to as advertiser parameters. The advertisers and/or the portal will recruit a brand that will accept the advertiser parameters and an advertisement device will be created for that brand. The advertisement device will then be distributed to the advertisers, and a campaign will be initiated. It its foreseeable that several brands will bid for the same group of advertisers, thus potentially providing the advertisers with even better rewards.

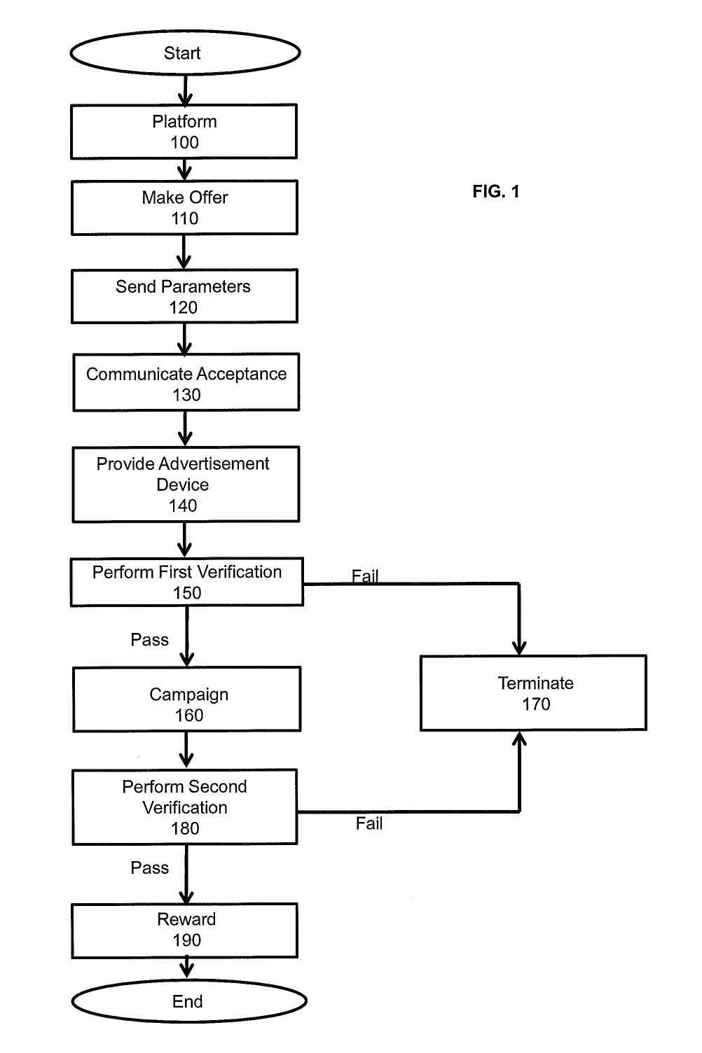

An exemplary embodiment is described in greater detail with reference to FIG. 1. At step 100 a brand, directly or through a retailer, manufacturer, licensor, advertising agency or other representative involves a platform to develop a promotional program to engage advertisers. At step 110, the brand makes an offer including brand parameters at the platform and the brand parameters are then sent out at step 120 to target advertisers identified by the platform. As stated previously, either the brands or advertisers may make an offer and submit parameters. Regardless who submits the parameters, however, brands can recruit advertisers and advertisers can, likewise, recruit brands. In the exemplary embodiment, the offer and its parameters are preferably presented to a web portal via electronic means, such as by email or by entering information at the portal, however, other means of submission are contemplated, such as by print, facsimile, or other transmission or delivery When a brand makes an offer and submits parameters, they are called brand parameters and can include but are not limited to duration of campaign, verification preferences, display preferences, such as vehicle part, compensation or promotion details, co-branding preferences, advertiser quota, available advertisement devices, advertiser preferences, such as, for example education level, and other similar rules and restrictions. When an advertiser or group of advertisers submit parameters, they are called advertiser parameters and can include, for example, the category of products or services they wish to promote, duration, verification preferences, display preferences, advertisement device preferences, and compensation or promotion preferences, to name a few.

Briefly, about the different parameters, display preferences may describe where the advertisement device is placed. For example, if the advertisement device is a bumper sticker, it may be placed on a bumper alone or with conjunction with other bumper stickers, or it may be placed elsewhere on a car. Advertisement device preferences relates to selecting a bumper sticker, a window decal, a sticker, a patch or another similar device. Compensation or promotion preferences relates to whether the advertiser will get paid for displaying a device, will receive a discount or another promotion, or participates in a not-for-profit or charitable effort. Verification preference relates to how many levels of verification are requested, that is, how many times and how often an image will need to be uploaded to portal and verified and how it will be verified, whether manually, electronically, or as a combination of the two. Advertiser quota relates to limiting the number of advertisers allowed into a certain campaign or specifying a minimum number of advertisers needed to activate a certain campaign or reward.

At step 130 those target advertisers who accept the offered brand parameters communicate their acceptance to the platform, thereby confirming their participation in the campaign and becoming advertisers. Identification or recruitment of target advertisers may be done by the platform, the target advertisers, advertisers, or by the brands themselves. Regardless of where or how an advertiser is recruited or identified, its participation in the campaign will be confirmed at the platform.

At step 140 an advertisement device is provided to the advertisers for public display on or in association with an advertisement device. When a bumper sticker is used as the advertising device, it may be delivered to the advertiser pre-printed or the advertiser may print a message on it, and attach it to the bumper of the advertisement medium, for example, a car. In some situations more than one advertising device may be issued, depending on the parameters. The advertiser may, at that time, upload an image of the advertising device attached to the advertising medium for a first verification at step 150. There may, however, be additional verifications, depending on the brand parameters.

When the advertising device is a bumper sticker or a window decal, there may be additional built-in security measures in the sticker or decal. For example, there may be a physical crease that can only be leveled out when the back is peeled and the sticker or decal is affixed to a surface. If the sticker or decal is not properly affixed to a bumper or another car surface, the crease will show and the advertiser will not pass the verification. Similar methods can be implemented on other advertising devices. The advertiser will be asked to upload an image of the bumper sticker affixed to the car and the image will be analyzed manually and/or electronically to be sure that it has not been altered or modified. For the verification, open source software such as JPEGSnoop™ may be used to verify that the image uploaded to the system has not been altered or modified in any way. Such software will preferably return a value correlating to a degree to which it thinks the image has been altered. Depending on that value, the verification will either need to be repeated, will be deemed successful, will be deemed failed, or will need further verification, such as manual verification. For example, there may be several classes into which an image may fall. Class 1 may be those images the software determines to have been processed or edited. Class 2 may be the images the software determines to have a high probability of having been processed or edited. Class 3 may be for images that software determines to have a high probability of being original, and Class 4 for images the software is uncertain about being processed or original. In some situations, the success of the first verification will determine whether or not the advertiser will be allowed to continue with the campaign. In such cases, if the verification is successful, the campaign will be continued at step 160. If the verification has failed, the participation may terminate at step 170. One or more attempts at verification can be made, depending on parameters.

After the first verification at step 150, the advertiser will go on to participate in the campaign at step 160 for a pre-determined period of time. The brand or advertiser parameters will specify how long the campaign should last. In some campaigns, a second verification may be implemented at step 180. The second verification may be the final verification or an intermediate verification. That is, it may be implemented at the end of campaign participation, or it may be implemented several times throughout campaign participation at pre-determined time intervals. Some brand parameters may specify that a second verification including a unique instruction be implemented every four weeks. Other brand parameters may specify that it is to be implemented only once, at the end of campaign participation and that the reward is released upon the completion of the second verification. Still other brand parameters may specify that no second verification is required at all. Thus, the second verification can be repeated n number of times depending on provided parameters.

For the second verification, the advertiser will receive a unique instruction to be implemented along with a second image to be uploaded to the portal. When the advertising device is a bumper sticker or window decal, the unique instruction may be to open the trunk of the car or to place an object on it. The unique instruction will be selected based on the advertising medium and on the advertisement device used by the advertiser.

If the advertiser passes the second verification, he will be allowed to either continue with the campaign until the next verification or end the campaign and receive reward at step 190. If, however, advertiser does not pass the second verification at step 180, the advertiser may be asked to verify again or the campaign may be terminated at step 170. The reward may be a payment to advertiser, a discount, a special deal or it may be the privilege to display a certain affiliation or sponsorship. For some campaigns, second verification 180 and reward 190 may be repeated several times.

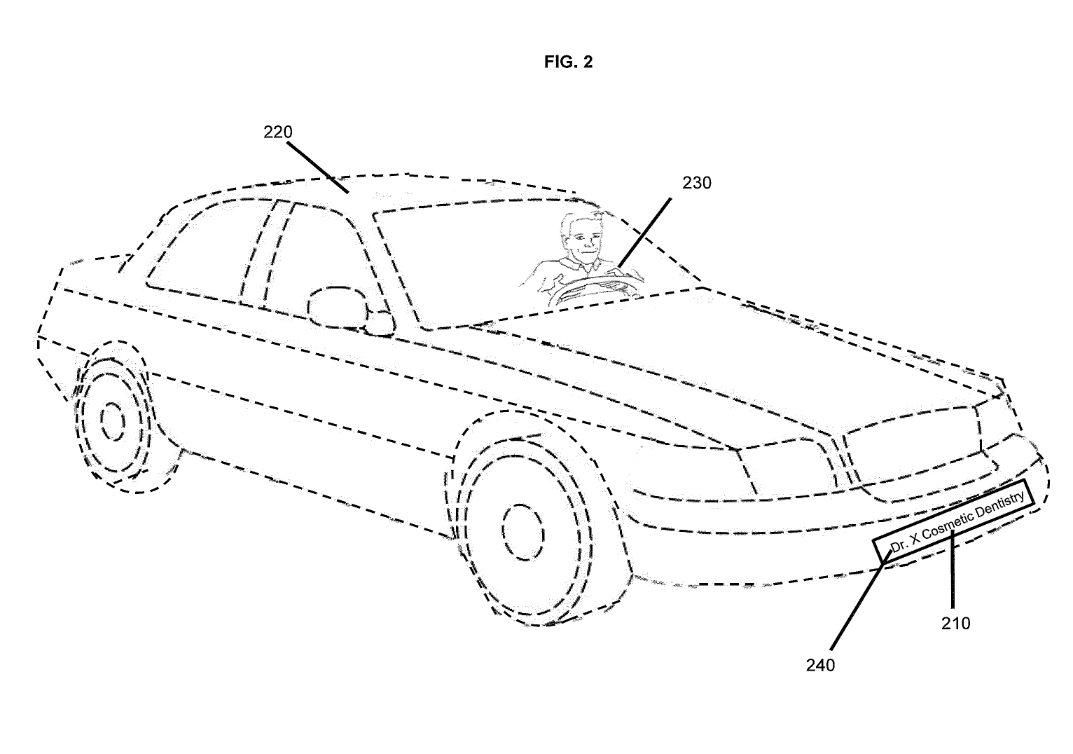

FIG. 2 depicts a system in accordance with an exemplary embodiment. Such system has an analog advertisement device 210 that can be applied to an advertisement medium 220. In this embodiment, it is a bumper sticker 210 that is attached to a bumper of a car 220 driven by advertiser 230. The advertiser is engaged in a campaign to promote brand message 240 of a certain brand according to the method described with reference to FIG. 1.

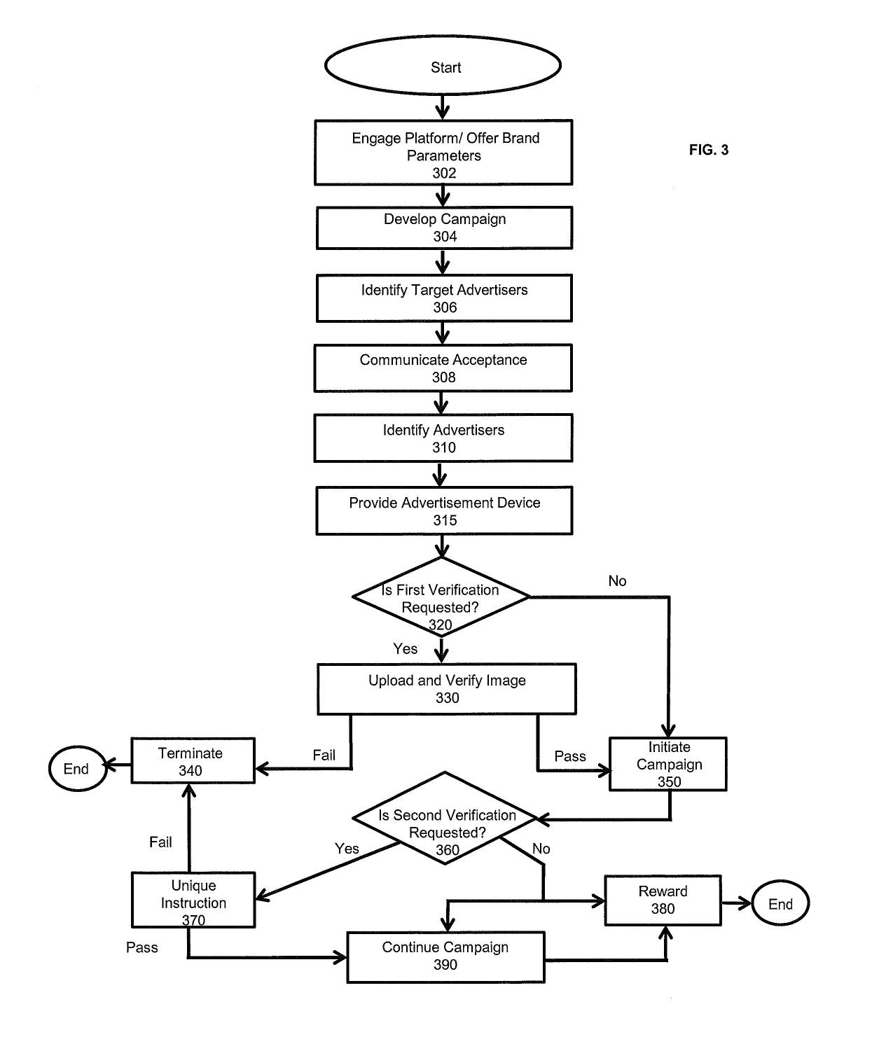

FIG. 3 depicts a flowchart representing another exemplary embodiment. According to an exemplary embodiment of FIG. 3, a brand will engage the platform for advertising purposes and offer its brand parameters at step 302. A campaign is then developed at step 304, and target advertisers are identified at step 306. At step 308, target advertisers who accept the offered brand parameters will communicate their acceptance of the offered brand parameters, thereby becoming advertisers at step 310. At step 315, advertisement devices will be provided to the advertisers.

A first query is deployed at the system regarding whether or not a first verification is requested in the provided parameters at step 320. If the answer to the query is positive and a first verification is requested, the advertiser will upload the first image of the advertising device attached to the advertising medium and the image will be verified at step 330. After the image is verified at step 330, if the image passes verification, the campaign is allowed to go on at step 350. If, however, the verification is not successful, the advertiser may be asked to repeat verification or campaign participation may be terminated at step 340. When the query returns a negative response from the system, no first verification will be requested from the advertiser and the campaign automatically is allowed to initiate at step 350. The advertiser will participate in the campaign for a pre-determined period of time. The brand or advertiser parameters will specify how long the campaign should last.

When the response to the first query is positive and a first verification is passed, a second query may be made regarding whether or not a second verification is required by the brand parameters at step 360. It is foreseeable that some brands who forego a first verification may request a second verification. This is for example, brands who need not verify if or how the advertisement device was affixed to an advertising medium, yet they wish to check that certain other verifications are respected, such as for example, periodic compliance.

A second query is deployed at the system regarding whether or not a second verification is requested in the provided parameters at step 360. As stated previously, the second verification may be the final verification or an intermediate verification. That is, it may be implemented at the end of campaign participation, or it may be implemented several times throughout campaign participation at pre-determined time intervals. If the answer to the query is positive and a second verification is requested, the advertiser will usually receive a unique instruction at step 370 to be implemented along with a second image to be uploaded to the portal. When the advertising device is a bumper sticker or window decal, the unique instruction may be to open the trunk of the car or to place an object on it. The unique instruction will be selected based on the advertising medium and on the advertisement device used by the advertiser. Some brand parameters may specify that a second verification including a unique instruction be implemented every four weeks. Other brand parameters may specify that it is to be implemented only once, at the end of campaign participation and that the reward is released upon the completion of the second verification. Still other brand parameters may specify that no second verification is required at all. Thus, the second verification can be repeated n number of times depending on provided parameters.

If the advertiser passes the second verification of the unique instruction, he will be allowed to continue with the campaign at step 390 until the next verification or until the campaign ends and the advertiser receives a reward at step 380. If, however, advertiser does not pass the verification, he may be asked to verify again or the campaign may be terminated at step 340. The reward may be a payment to advertiser, a discount, a special deal or it may be the privilege to display a certain affiliation or sponsorship. For some campaigns, verification and reward steps may be repeated several times until the relationship is terminated. Thus, rewards may be issued once, at the end of a campaign, or periodically.

When the query returns a negative response from the system, no second verification will be requested from the advertiser at step 360 and the advertiser may receive a reward at step 380 or continue with the campaign at step 390 until the reward is received at step 380.

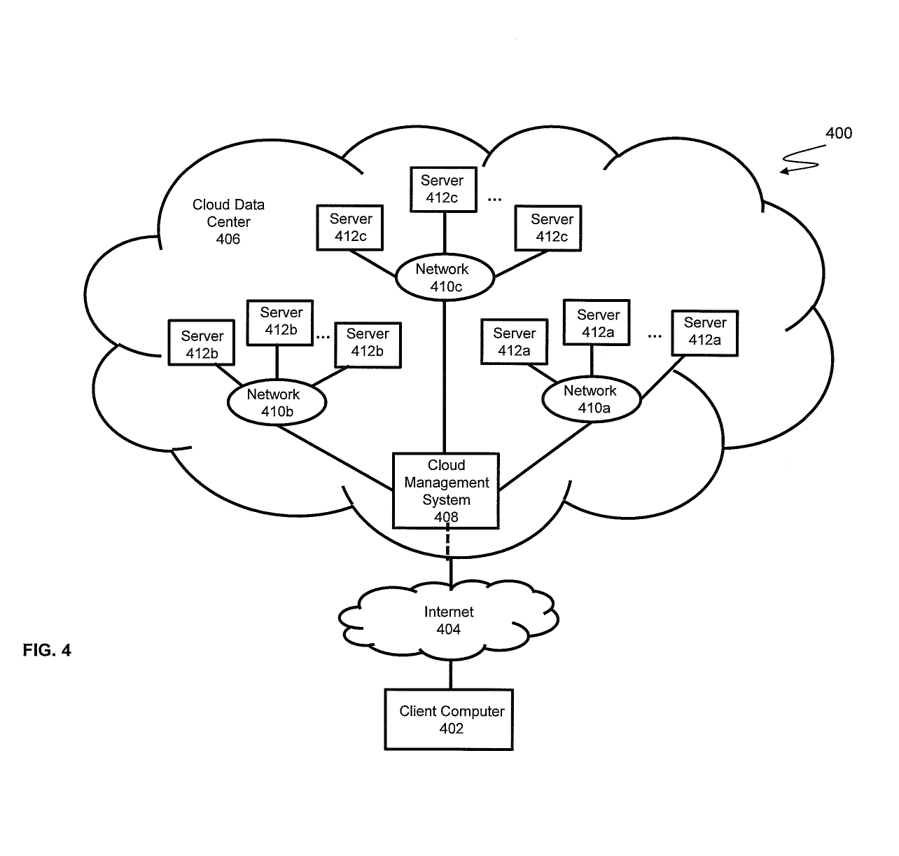

FIG. 4 is a diagram of a network architecture through which a platform of the present invention may be accessed according to another exemplary embodiment. FIG. 4 specifically illustrates a cloud computing system which may allow access to a platform for communication between brands and potential brand advertisers. FIG. 4 illustrates an exemplary cloud computing system 400 that may be used to implement the methods according to the present invention. The cloud computing system 400 includes a plurality of interconnected computing environments. The cloud computing system 400 utilizes the resources from various networks as a collective virtual computer, where the services and applications can run independently from a particular computer or server configuration making hardware less important.

Specifically, the cloud computing system 400 includes at least one client computer 402. The client computer 402 may be any device through the use of which a distributed computing environment may be accessed to perform the methods disclosed herein, for example, a traditional computer, portable computer, mobile phone, personal digital assistant, tablet to name a few. The client computer 402 includes memory such as random access memory (“RAM”), read-only memory (“ROM”), mass storage device, or any combination thereof. The memory functions as a computer usable storage medium, otherwise referred to as a computer readable storage medium, to store and/or access computer software and/or instructions.

The client computer 402 also includes a communication interface, for example, a modem, a network interface (such as an Ethernet card or Ethernet cable), a communication port, a PCMCIA slot and card, wired or wireless systems, etc. The communication interface allows communication through transferred signals between the client computer 402 and external devices including networks such as the Internet 404 and cloud data center 406. Communication may be implemented using wireless or wired capability such as cable, fiber optics, a phone line, a cellular phone link, radio waves or other communication channels.

The client computer 402 establishes communication with the Internet 404—specifically to one or more servers—to, in turn, establish communication with one or more cloud data centers 406. A cloud data center 406 includes one or more networks 410a, 410b, 410c managed through a cloud management system 408. Each network 410a, 410b, 410c includes resource servers 412a, 412b, 412c, respectively. Servers 412a, 412b, 412c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 408 can comprise a dedicated or centralized server and/or other software, hardware, and network tools to communicate with one or more networks 410a, 410b, 410c, such as the Internet or other public or private network, with all sets of resource servers 412a, 412b, 412c. The cloud management system 408 may be configured to query and identify the computing resources and components managed by the set of resource servers 412a, 412b, 412c needed and available for use in the cloud data center 406. Specifically, the cloud management system 408 may be configured to identify the hardware resources and components such as type and amount of processing power, type and amount of memory, type and amount of storage, type and amount of network bandwidth and the like, of the set of resource servers 412a, 412b, 412c needed and available for use in the cloud data center 406. Likewise, the cloud management system 408 can be configured to identify the software resources and components, such as type of Operating System (“OS”), application programs, and the like, of the set of resource servers 412a, 412b, 412c needed and available for use in the cloud data center 406.

The cloud computing system 400 of FIG. 4 is provided only for purposes of illustration and does not limit the invention to this specific network architecture embodiment. It is appreciated that a person skilled in the relevant art knows how to program and implement the invention using any computer system or network architecture, either known at the time of filing or in the future.

Various exemplary embodiments have been described above. Those skilled in the art will understand, however, that changes and modifications may be made to those examples without departing from the scope of the claims.

What is claimed is:

1. A method for promoting a brand by advertiser engagement comprising the steps of:
developing a campaign using engagement of one or more advertisers to promote a brand, the campaign including identification of target advertisers who will receive brand parameters, acceptance of the brand parameters by the one or more advertisers, public display by the one or more advertisers of an advertisement device on or in association with an advertisement medium in compliance with the brand parameters in order to obtain a reward;
identifying target advertisers;
presenting brand parameters to target advertisers;
receiving acceptance notification from the target advertisers who accept the brand parameters to become the one or more advertisers;
delivering the advertisement device to the one or more advertisers for public display on or in association with an advertisement medium in compliance with the brand parameters;
conducting at least one verification to determine whether the one or more advertisers publicly displayed the advertisement device on or in association with an advertisement medium in compliance with the brand parameters; and
providing the reward to the one or more advertisers.

2. The method of claim 1, wherein the advertisement display is analog.

3. The method of claim 1, wherein the advertisement medium is analog.

4. The method of claim 1, wherein the at least one verification further comprises compliance with a unique instruction not presented in the brand parameters.

5. The method of claim 4, wherein the unique instruction is supplied by a third party.

6. A system for promoting a brand by engagement of one or more advertisers, said system comprising:
an advertisement device that can be applied to an advertisement medium;
a reward for compliance with brand parameters; and
a campaign using engagement of one or more advertisers to promote a brand, the campaign including identification of target advertisers who will receive brand parameters, acceptance of the brand parameters by the one or more advertisers, public display by the one or more advertisers of an advertisement device on or in association with an advertisement medium in compliance with the brand parameters in order to obtain the reward

7. The system of claim 6, wherein the advertisement device is analog.

8. The system of claim 6, wherein the advertisement medium is analog.

9. A method for advertising products and services of a brand comprising the steps of:
identifying target advertisers;
submitting a promotional offer to the target advertisers;
receiving an acceptance notification from each of the target advertisers who accept the promotional offer to become one or more advertisers;
delivering an advertisement device to the one or more advertisers for display on or in association with an advertisement medium in compliance with the promotional offer;
conducting at least one verification to determine whether the one or more advertisers displayed the advertisement device on or in association with an advertisement medium in compliance with the promotional offer in order that the one or more advertisers obtains a reward; and
providing the reward to the one or more advertisers.

10. The method of claim 9 wherein the displayed on or in association with an advertisement medium is a public display.

11. The method of claim 9 wherein the advertisement device is analog.

12. The method of claim 9 wherein the advertisement medium is analog.

13. A method for promoting a product or service by advertiser engagement comprising the steps of:
delivering a promotional offer by an at least one advertiser to a brand that the at least one advertiser will display an advertisement device on or in association with an advertisement medium so that the at least one advertiser can obtain a reward;
entering an arrangement in which the brand accepts the promotional offer of the at least one advertiser;
verifying that the at least one advertiser has complied with the terms of the promotional offer; and
providing the at least one advertiser with the reward.

14. The method of claim 13, further comprising issuing an advertisement device to the at least one advertiser.

15. The method of claim 13, wherein the advertisement device is analog.

16. The method of claim 13, wherein the advertisement medium is analog.

17. The method of claim 14, wherein the brand issues the advertisement device.

18. The method of claim 14, wherein a third party issues the advertisement device.
